(19) United States
(12) Patent Application Publication
(10) Pub. No.: US 2025/0021474 A1
(43) Pub. Date: Jan. 16, 2025

(54) ENCODING AND RETRIEVAL OF SYNTHETIC MEMORIES FOR A GENERATIVE MODEL FROM A USER INTERACTION HISTORY INCLUDING MULTIPLE INTERACTION MODALITIES

(71) Applicant: Microsoft Technology Licensing, LLC, Redmond, WA (US)

(72) Inventors: Umesh MADAN, Bellevue, WA (US); Samuel Edward SCHILLACE, Portola Valley, CA (US); Brian Scott KRABACH, Snohomish, WA (US)

(73) Assignee: Microsoft Technology Licensing, LLC, Redmond, WA (US)

(21) Appl. No.: 18/478,894

(22) Filed: Sep. 29, 2023

Related U.S. Application Data
(60) Provisional application No. 63/513,696, filed on Jul. 14, 2023.
(60) Provisional application No. 63/514,776, filed on Jul. 20, 2023.

(51) Int. Cl. G06F 12/02; G06F 40/20

(52) U.S. Cl. CPC G06F 12/0238; G06F 40/20; G06N 5/022; G06N 5/04

(57) ABSTRACT

According to one aspect, a computing system is provided that includes processing circuitry configured to receive input data from multiple interaction modalities of a user, generate a multi-interaction-modality user interaction history from the input data, and extract memories from the multi-interaction-modality user interaction history using a trained memory-extracting generative model. The memories include natural language text descriptions of interactions in the user interaction history generated by the trained memory-extracting generative model. The processing circuitry is further configured to store the memories in file storage having an associated database with a vector search interface configured to receive memory retrieval queries. The computing system may further be configured to receive a user message via an interaction interface, retrieve relevant memories, generate a response-generating prompt with the user message and relevant memories, and use the prompt to generate a response to the user message with a generative language model.

### CROSS REFERENCE TO RELATED APPLICATIONS

This application claims priority to U.S. Provisional Patent Application No. 63/513,696, filed Jul. 14, 2023, and to U.S. Provisional Patent Application No. 63/514,776, filed Jul. 20, 2023, the entirety of each of which is hereby incorporated herein by reference for all purposes.

### BACKGROUND

Recently, large language models (LLMs) have been developed that generate natural language responses in response to prompts entered by users. LLMs are incorporated into chatbots, which are computer programs designed to interact with users in a natural, conversational manner. Chatbots facilitate efficient and effective interaction with users, often for the purpose of providing information or answering questions.

Notwithstanding the advancements and widespread usage of LLM-enabled chatbots, a significant issue persists in their operation: the loss of context from the user interaction history. This challenge primarily arises from the inability of chatbots to effectively capture, store, and leverage previous interactions with a user. Chatbots often lack the capability to refer back to past conversations and bring forward relevant information to a current interaction. This limitation can result in a disjointed user experience and a conversational deficit, where context and continuity are lost.

### SUMMARY

Computing systems and methods to address the above issues are disclosed herein. According to one aspect, a computing system for synthetic memory encoding is provided. The computing system includes processing circuitry configured to receive input data from multiple interaction modalities of a user, and generate a multi-interaction-modality user interaction history from the input data, and extract memories from the multi-interaction-modality user interaction history using a trained memory-extracting generative model. The memories include natural language text descriptions of interactions in the user interaction history generated by the trained memory-extracting generative model. The processing circuitry is further configured to store the memories in file storage having an associated database with a vector search interface configured to receive memory retrieval queries.

According to another aspect, a computing system for synthetic memory retrieval, is provided. The computing system includes processing circuitry configured to instantiate an interaction interface for a trained generative model, receive, via the interaction interface, a user message including text, generate a context for the user message, and send a memory retrieval request to a memory retrieval agent, the memory retrieval request including the context and the user message. The processing circuitry is further configured to receive relevant memories from the memory retrieval agent. The relevant memories retrieved in this manner have been extracted from a multi-interaction-modality user interaction history created using a trained memory-extracting generative model. The retrieved relevant memories include natural language text descriptions of interactions from multiple interaction modalities included in the multi-interaction-modality user interaction history.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a schematic view showing a computing system according to a first example implementation.

FIG. 1B is a schematic view showing a computing system according to a second example implementation.

FIG. 2 is a schematic view showing an input and an output of a prompt generator of the computing system of FIG. 1A, according to an example implementation.

FIG. 3 is a schematic view showing an input and an output of a memory-extracting trained generative model of the computing system of FIG. 1A in generating a synthetic memory from a user interaction history, according to an example implementation.

FIG. 4 is a schematic view showing an input and an output of a memory-extracting trained generative model of the computing system of FIG. 1A in generating a synthetic memory from a memory cluster according to an example implementation.

FIG. 5 shows an example graphical user interface of the computing system of FIG. 1A, illustrating the incorporation of information from the persistent user interaction history in the response.

FIG. 6 shows a flowchart for a method according to one example implementation.

FIG. 7 is a schematic view showing a computing system according to a third example implementation, engaged in the process of encoding synthetic memories based on a user interaction history including multiple interaction modalities.

FIG. 8 is a schematic view showing a computing system according to the third example implementation, engaged in the process of retrieving relevant synthetic memories to generate a prompt for a trained generative model to generate a response to a user message.

FIG. 9 shows a schematic view of the computing system of FIGS. 7 and 8 clustering the synthetic memories into memory clusters stored in memory banks, using a density based clustering algorithm, according to one example implementation.

FIG. 10 shows a flowchart of a method according to one example implementation.

FIG. 11 shows a schematic view of an example computing environment in which the computing system of FIG. 1A, 1B, 7, or 8 may be enacted.

### DETAILED DESCRIPTION

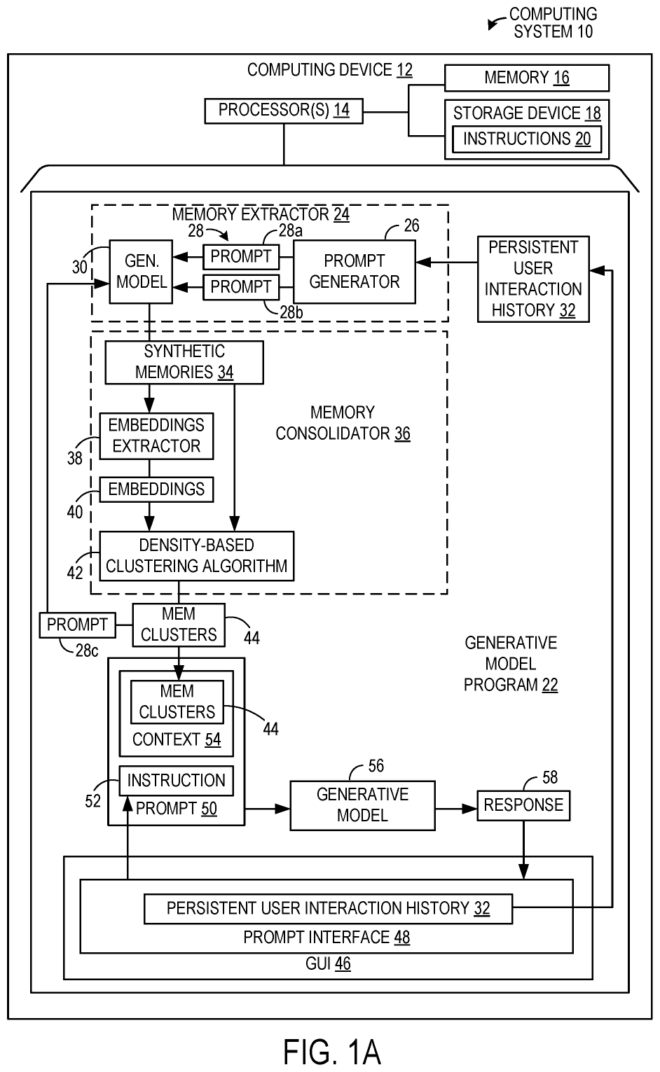

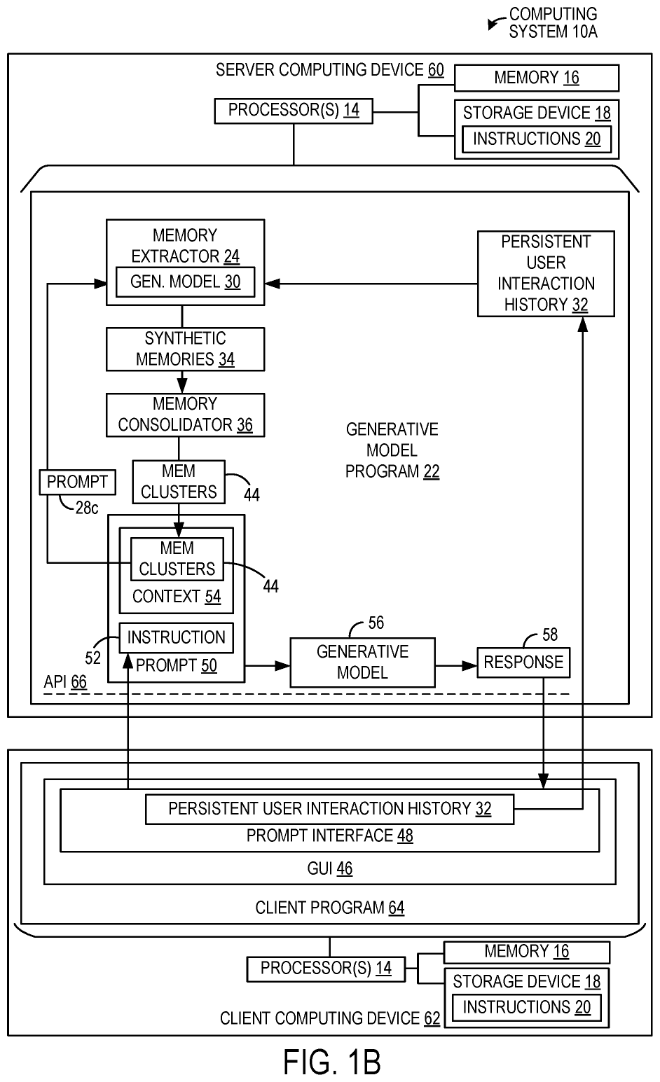

To address the issues described above, FIG. 1A illustrates a schematic view of a computing system 10 according to a first example implementation. The computing system 10 includes a computing device 12 having processing circuitry 14, memory 16, and a storage device 18 storing instructions 20. In this first example implementation, the computing system 10 takes the form of a single computing device 12 storing instructions 20 in the storage device 18, including a trained generative model program 22 that is executable by the processing circuitry 14 to perform various functions including memory extraction and memory consolidation by a memory extractor 24 and a memory consolidator 26, respectively.

The processing circuitry 14 may be configured to cause a prompt interface 48 for at least a trained generative model 56 to be presented. In some instances, the prompt interface 48 may be a portion of a graphical user interface (GUI) 46 for accepting user input and presenting information to a user. In other instances, the prompt interface 48 may be presented in non-visual formats such as an audio interface for receiving and/or outputting audio, such as may be used with a digital assistant. In yet another example the prompt interface 48 may be implemented as a prompt interface application programming interface (API). In such a configuration, the input to the prompt interface 48 may be made by an API call from a calling software program to the prompt interface API, and output may be returned in an API response from the prompt interface API to the calling software program. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the prompt interface API (e.g., prompt interface 48) for the trained generative model 56.

In general, the processing circuitry 14 may be configured to receive, via the prompt interface 48 (in some implementations, the prompt interface API), an instruction 52, which is incorporated into a prompt 50. The trained generative model 56 receives the prompt 50, which includes the instruction 52, and produces a response 58. It will be understood that the instruction 52 may also be generated by and received from a software program, rather than directly from a human user. The prompt 50 may be inputted into the trained generative model 56 by an API call from a client to a server hosting the trained generative model 56, and the response 58 may be received in an API response from the server. Alternatively, the input of the prompt 50 into the trained generative model 56 and the reception of the response 58 from the trained generative model 56 may performed at one computing device.

The prompt generator 26 receives input of a persistent user interaction history 32 of a user, which is not limited to, but exemplified by a persistent chat history of an interaction between a chatbot and a user. The user interaction history may include messages in the chat history as well as contextual information used to generate the messages. The contextual information in the persistent user interaction history 32 may include transaction histories, browsing histories, social media activity histories, game play histories, text input histories, and other contextual information that were used to generate the prompts sent to the generative model as input during the user interactions. Thus, the persistent user interaction history 32 can be configured as a record or log capturing the entirety of messages, queries, responses, and other relevant information exchanged during the interaction timeline. The persistent user interaction history 32 may also include timestamps and any additional metadata associated with each interaction. Alternatively, a subset of the aforementioned contextual information may be included in the persistent user interaction history 32. The persistent user interaction history 32 can be configured to save and retain a user interaction history across multiple interaction sessions. The persistent user interaction history 32 is said to be persistent because it can retain user interaction histories from prior sessions in this manner, rather than deleting or forgetting such prior user interaction histories in an ephemeral manner.

Responsive to receiving the persistent user interaction history 32, the prompt generator 26 generates one or more memory-extracting prompts 28 to be inputted into the memory-extracting trained model 30, which may be identical to the trained generative model 56 or separate from the trained generative model 56. Both the trained model 30 and the trained generative model 56 are generative models that have been configured through machine learning to receive input that includes natural language text and generate output that includes natural language text in response to the input. It will be appreciated that the memory-extracting trained model 30 and the trained generative model 56 can be large language models (LLMs) having tens of millions to billions of parameters, non-limiting examples of which include GPT-3 and BLOOM, or alternatively configured as other architectures of generative models, including various forms of diffusion models, generative adversarial networks, and multi-modal models. Either or both of the memory-extracting trained model 30 and the trained generative model 56 can be multi-modal generative language models configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-1, GPT-4, and LLaMA. Further, either or both of the memory-extracting trained model 30 and the trained generative model 56 can be configured to have a generative pre-trained transformer architecture, examples of which are used in the GPT-3 and GPT-4 models.

The memory-extracting prompts 28 include instructions to transform the persistent user interaction history 32 into synthetic memories 34, which are stored in a memory bank of the storage device 18. The persistent user interaction history 32 may be incorporated into one memory-extracting prompt 28a, or divide the persistent user interaction history 32 into a plurality of parts, and incorporate these parts into two or more memory-extracting prompts 28a, 28b, respectively, to extract synthetic memories 34 from the plurality of parts. As used herein the term “memories” refers to output generated by a generative model in response to a memory-extracting prompt including a portion of the user interaction history (or memory or memories generated therefrom) between a user and software components of a computing system. Depending on the configuration of the generative model, as described below, the memories can include natural language text, images, and/or audio. The memories are referred to as “synthetic” because they are programmatically generated according to the processes described herein from the raw data in the user interaction history or memories thereof by the generative model.

For example, the division of the persistent user interaction history 32 may be performed according to criteria such as the subject of the user interactions, the times at which the user interactions occurred, or the platforms or application programs via which the user interactions took place. In one implementation, to divide email threads based on the subject of the emails, the persistent user interaction history 32 may be divided into distinct groups: one containing work-related e-mails, and another containing personal-related e-mails. For example, these groups may be established based on the user account (work or personal) or based on a trained subject classifier that reads recipient sender subject and/or bodies of emails to classify the emails into work or personal groups. In a different implementation, the persistent user interaction history 32 may be segmented by specific time periods, such as days, weeks, months, or years. In yet another implementation, the persistent user interaction history 32 may be categorized to group e-mail interactions together in one part, group text message interactions together in another part, and group user interactions with application programs such as word processors, spreadsheets, or web browsers in other respective parts.

As illustrated in the subsequent examples, the extraction of synthetic memories 34 by the memory-extracting trained model 30 is not the mere recording or filtering of raw data, but the summary or encapsulation of the essence of the interactions in the persistent user interaction history 32 in accordance with instructions in a prompt 28. As such, the synthetic memories 34 offer an intelligent, context-aware reflection of the interactions in the persistent user interaction history 32.

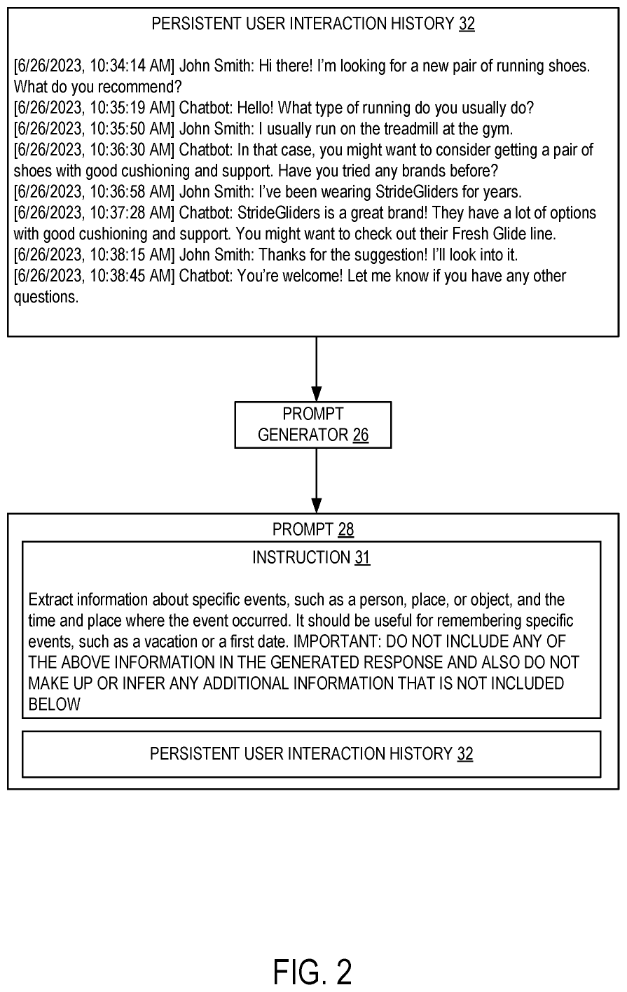

Turning to FIG. 2, an example of a persistent user interaction history 32 and a memory-extracting prompt 28 are shown, in which the prompt generator 26 generates a memory-extracting prompt 28 which incorporates the persistent user interaction history 32. In this example, the user John Smith asks the chatbot for recommendations for a new pair of running shoes. The persistent user interaction history 32 includes timestamps indicating when each message was sent or received. The generated memory-extracting prompt 28 includes the persistent user interaction history 32 and an instruction 31 to extract information about specific events, such as person, place, or object, and the time and place where the event occurred. The instruction 31 may include commands to extract information about the participants of the chat session as well as specific objects, specific people, and/or specific places that were mentioned during the user interaction session. The instruction 31 may also include a memory-extracting action indicating the manner in which the memory is to be generated, such as summarize, categorize, outline, highlight, or spotlight, for example, one of the persons, places, objects, or times in the user interaction history or memories thereof. Further, the instruction 31 can include a command to find portions of a one or a group of memories that are related to a particular topic (person, place, object, time, etc.) and connect and generate a new memory (or consolidate the group of memories into a replacement memory) that summarizes, categorizes, outlines, highlights, or spotlights the topic. In this way, new memories can be generated based on aspects of prior memories according to the instruction 31.

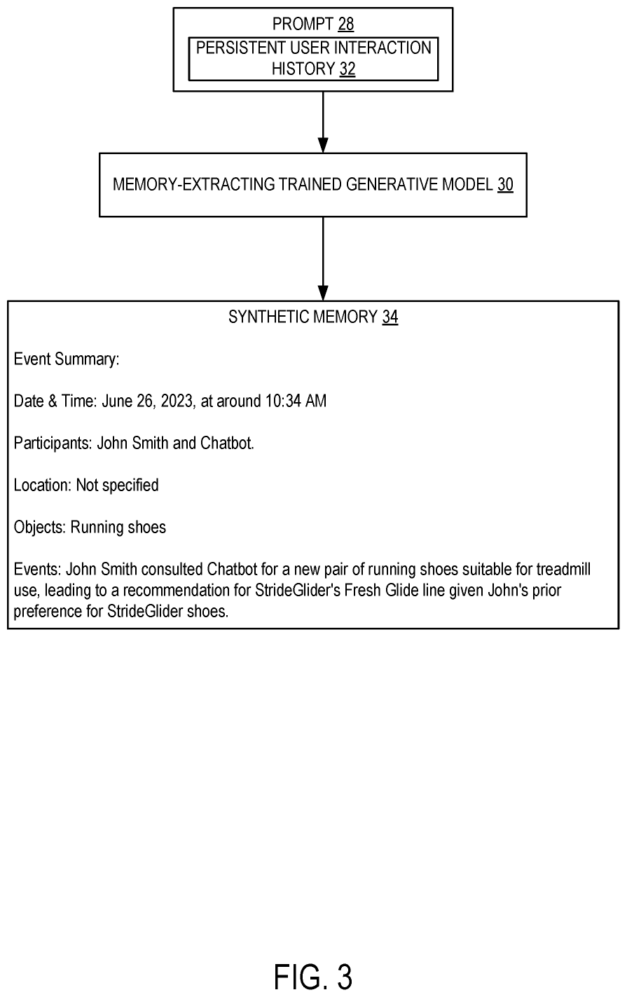

Turning to FIG. 3, an example is illustrated of the synthetic memory 34 generated by the memory-extracting trained model 30 based on the memory-extracting prompt 28 generated in the example of FIG. 2. The memory-extracting trained model 30 follows the instructions 31 in the memory-extracting prompt 28 to extract, from the persistent user interaction history 32, information about the chat, including the participants and the time when the chat occurred. In this example, the synthetic memory 34 generated by the memory-extracting trained model 30 indicates that a conversation happened between John Smith and the chatbot at around 10:34 AM on Jun. 26, 2023. The location was unspecified, and the objects discussed were running shoes. The brief summary in the synthetic memory 34 indicates that John Smith consulted the chatbot for a new pair of running shoes suitable for treadmill use, leading to a recommendation for StrideGlider's Fresh Glide line given John's prior preference for StrideGlider shoes.

Returning to FIG. 1A, the synthetic memories 34, which include summaries of past user interaction sessions, are processed by the memory consolidator 26 to be consolidated into memory clusters 44. The memory consolidator 26 comprises an embeddings extractor 38 configured to extract high-dimensional vectors or embeddings 40 from the synthetic memories 34 and store the embeddings 40 in a memory bank of the storage device 18, and a density-based clustering algorithm 42 configured to group the synthetic memories 34 into memory clusters 44 based on relative distances between the embeddings 40. The memory clusters 44 with the consolidated memories are then stored in a memory bank of the storage device 18. The synthetic memories 34 which were consolidated into the memory clusters 44 may be subsequently deleted from the storage device 18.

The memory consolidator 26 may run in the background on active memory by operating continuously and concurrently with other processes that are running on the processing circuitry 14, utilizing active or volatile memory 16 for the operation of the memory consolidator 26, so as to utilize the processor cycles that are not being used by foreground processes, which may include user-facing applications or services. Accordingly, memory consolidation may be performed by the memory consolidator 26 without interrupting any active tasks that a user is engaged in on the computing system 10.

The embeddings 40 may be contextual embeddings which capture the context of words within a sentence, sentence embeddings which represent entire sentences as vectors, entity embeddings which represent entities such as people, places, or organizations, and/or dialogue embeddings which represent the interactions and overall context within a chat session.

The density-based clustering algorithm 42 is configured to spatially organize or cluster the embeddings 40 by considering their relative distances in the embeddings space, assuming that embeddings 40 which are closer together in the high-dimensional space tend to originate from similar or related interactions. Accordingly, the combination of the embeddings extractor 38 and the density-based clustering algorithm 42 aids in the utilization of past interaction data in the current interactions of the chatbot. The density-based clustering algorithm 42 may be DBSCAN (Density-Based Spatial Clustering of Applications with Noise), HDBSCAN (Hierarchical DBSCAN), or OPTICS (Ordering Points to Identify the Clustering Structure), for example.

The memory clusters 44 are subsequently incorporated into the prompt 50 as a prompt context 54 along with the instruction 52 from the user, before the prompt 50 is inputted into the trained generative model 56 to generate the response 58. The response 58 is displayed on the prompt interface 48 as part of the persistent user interaction history 32. The memory clusters 44 may be further consolidated by inputting a memory-extracting prompt 28c including the memory clusters 44 into the memory extractor 24.

It will be appreciated that, while FIG. 1A depicts an example of the extraction of embeddings 40 from synthetic memories 34 which include summaries of past chat sessions between the user and the chatbot, it will be appreciated that the format of the data, from which the embeddings 40 are extracted, is not particularly limited, and any data, whether textual or structured data types, including JSON-formatted data, may be inputted into the embeddings extractor 38 to extract embeddings 40, so that the data are subsequently clustered into memory clusters 44. Moreover, the memory consolidator 26 may be configured to consolidate not only synthetic memories 34 extracted from a chat history, but also extracted from other types of user interaction histories, including transaction histories, browsing histories, social media activity histories, game play histories, text input histories, and others.

Furthermore, the memory consolidator 26 may be configured to consolidate not only synthetic memories 34 which are semantic data such as natural language text, but also multi-modal synthetic memories 34 which encompass not only text but also images and audio. Such multi-model synthetic memories 34 may be extracted from a memory-extracting trained model 30 which is configured as a multi-modal generative model.

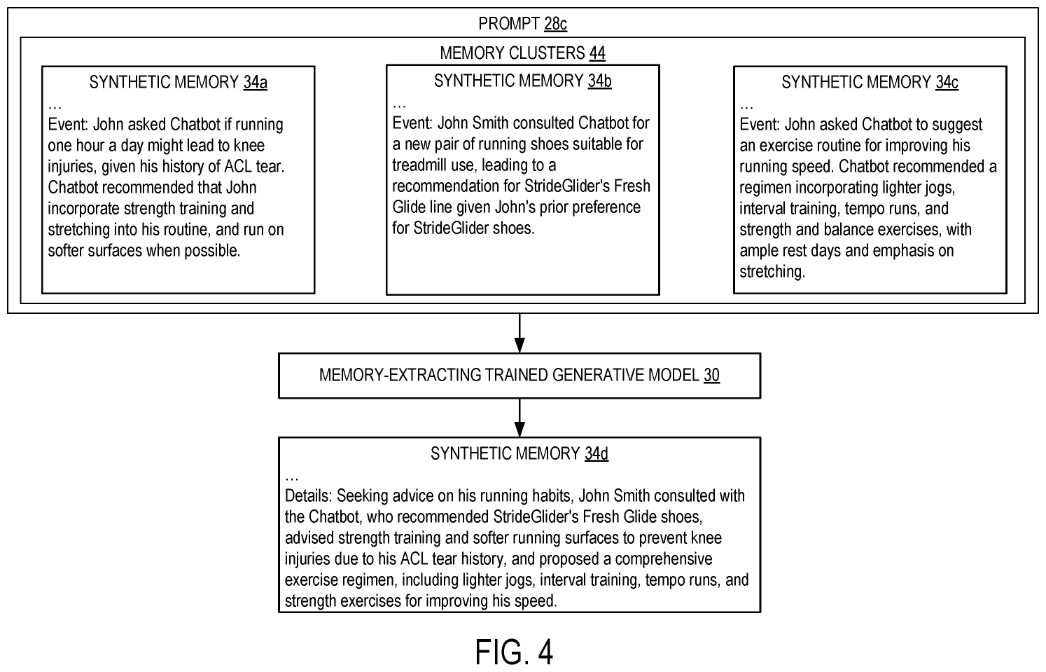

Turning to FIG. 4, an example is illustrated of memory clusters 44 that are further consolidated through a memory-extracting prompt 28c that includes the memory clusters 44. In this example the memory clusters 44 include a first synthetic memory 34a about a chat in which John Smith consulted the chatbot about reducing his risk of injuries during workouts, a second synthetic memory 34b about a chat in which John Smith consulted the chatbot about a recommendation for a new pair of running shoes that were suitable for treadmill use, and a third synthetic memory 34c about a chat in which John Smith asked about a workout routine to improve his running speeds. The memory-extracting prompt 28c includes instructions to consolidate the synthetic memories 34a-c. The memory-extracting trained model 30 processes the memory-extracting prompt 28c to output a consolidated synthetic memory 34d which summarizes the first, second and third synthetic memories 34a-c: “Seeking advice on his running habits, John Smith consulted with the chatbot, who recommended StrideGlider's Fresh Glide shoes, advised strength training and softer running surfaces to prevent knee injuries due to his anterior cruciate ligament (ACL) tear history, and proposed a comprehensive exercise regimen, including lighter jogs, interval training, tempo runs, and strength exercises for improving his speed”.

Turning to FIG. 1B, a computing system 10A according to a second example implementation is illustrated, in which the computing system 10A includes a server computing device 60 and a client computing device 62. Here, both the server computing device 60 and the client computing device 62 may include respective processing circuitry 14, memory 16, and storage devices 18. Description of identical components to those in FIG. 1A will not be repeated. The client computing device 62 may be configured to present the prompt interface 48 as a result of executing a client program 64 by the processing circuitry 14 of the client computing device 62. The client computing device 62 may be responsible for communicating between the user operating the client computing device 62 and the server computing device 60 which executes the trained model program 22 and contains the trained generative models 30 and 56, via an application programming interface (API) 66 of the trained model program 22. The client computing device 62 may take the form of a personal computer, laptop, tablet, smartphone, smart speaker, etc. The same processes described above with reference to FIG. 1A may be performed, except in this case the instruction 52 and response 58 may be communicated between the server computing device 60 and the client computing device via a network such as the Internet.

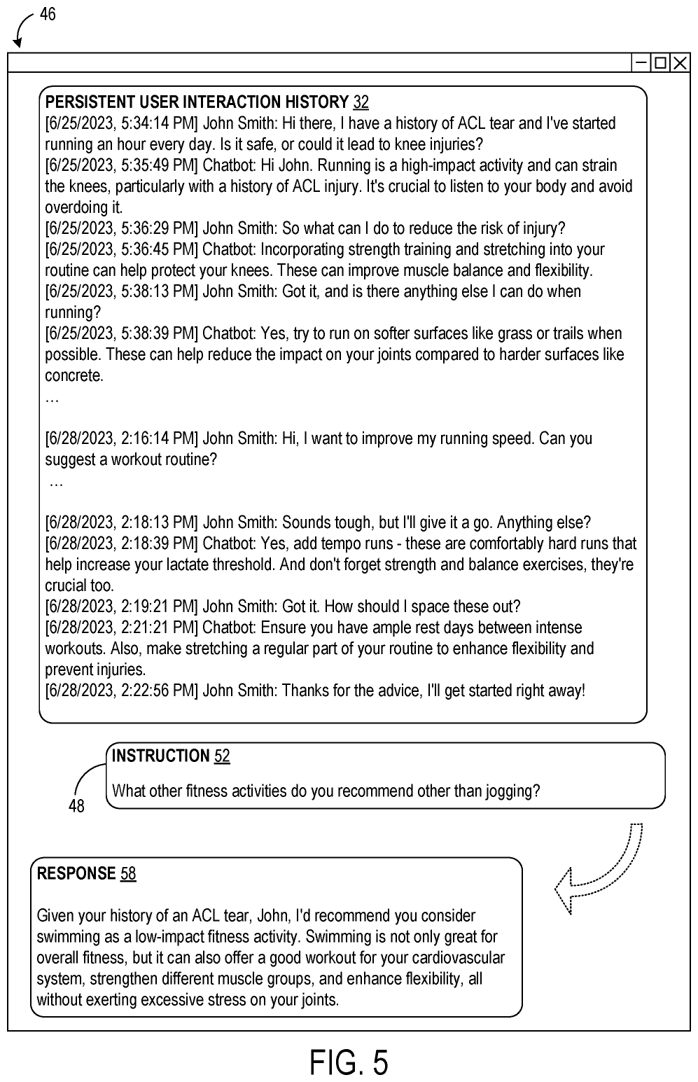

Turning to FIG. 5, an example is described of a chat between a user and a chatbot, in which the chatbot recalls information from a past conversation with the user. In this example, the persistent user interaction history 32 includes past exchanges in which John Smith anxiously mentioned his history of ACL tear as he asked if running was a safe workout activity for him. Therefore, when the user asked the chatbot about other recommended fitness activities in an instruction 52 incorporated into the prompt 50, the trained generative model 56 generated a response 58 including a recollection about his history of ACL tear, and the outputted fitness recommendations in the generated response 58 took this recollection into account.

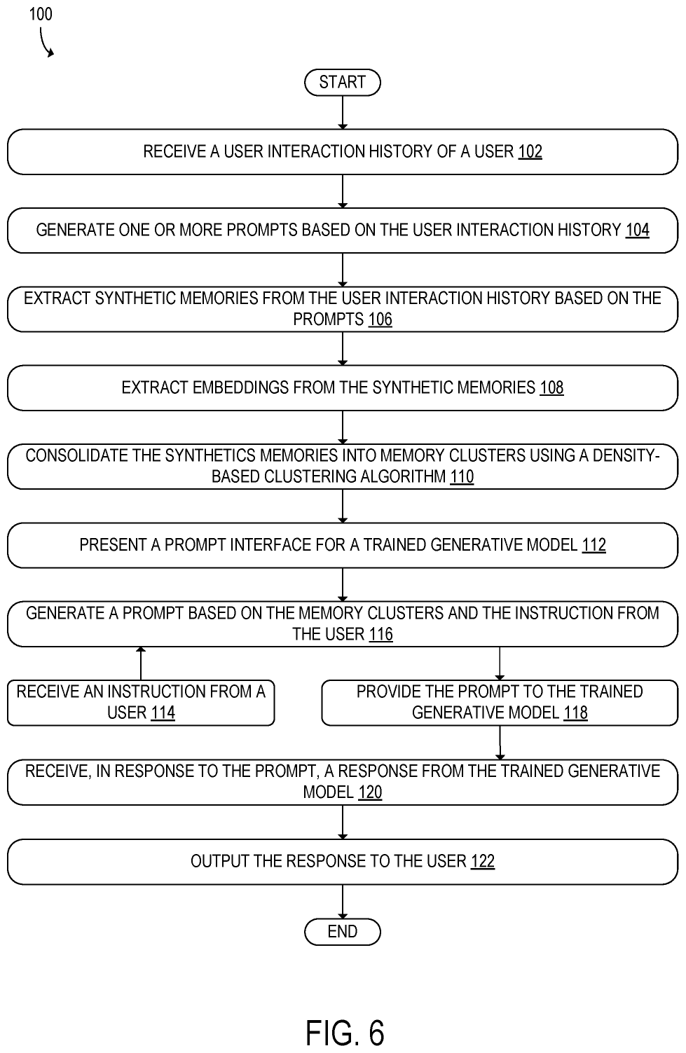

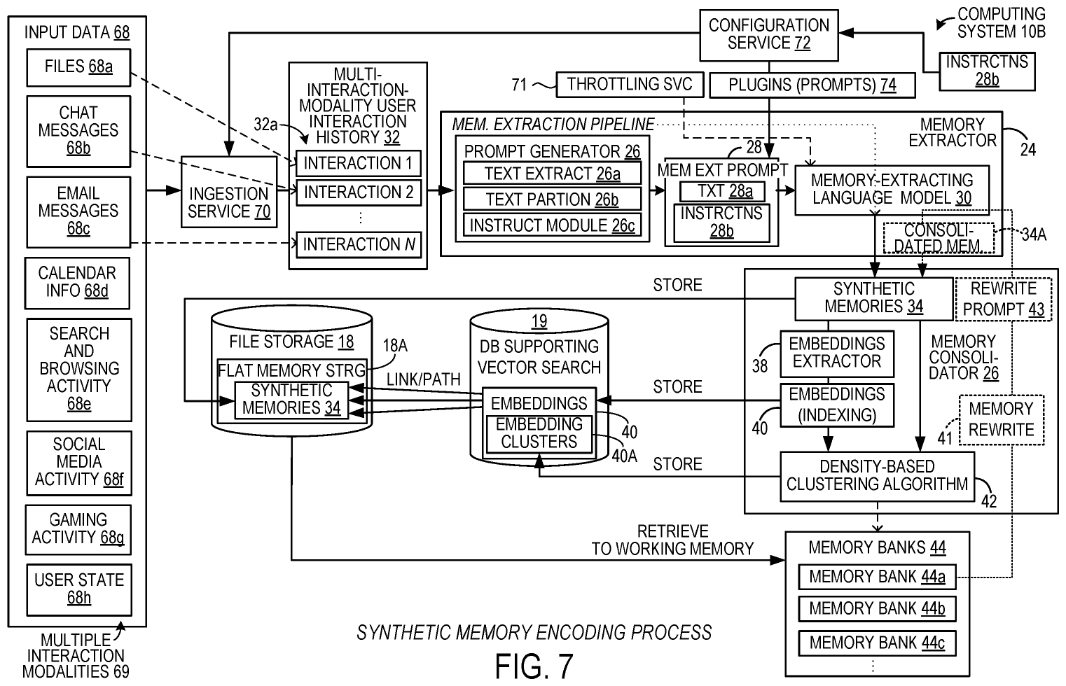

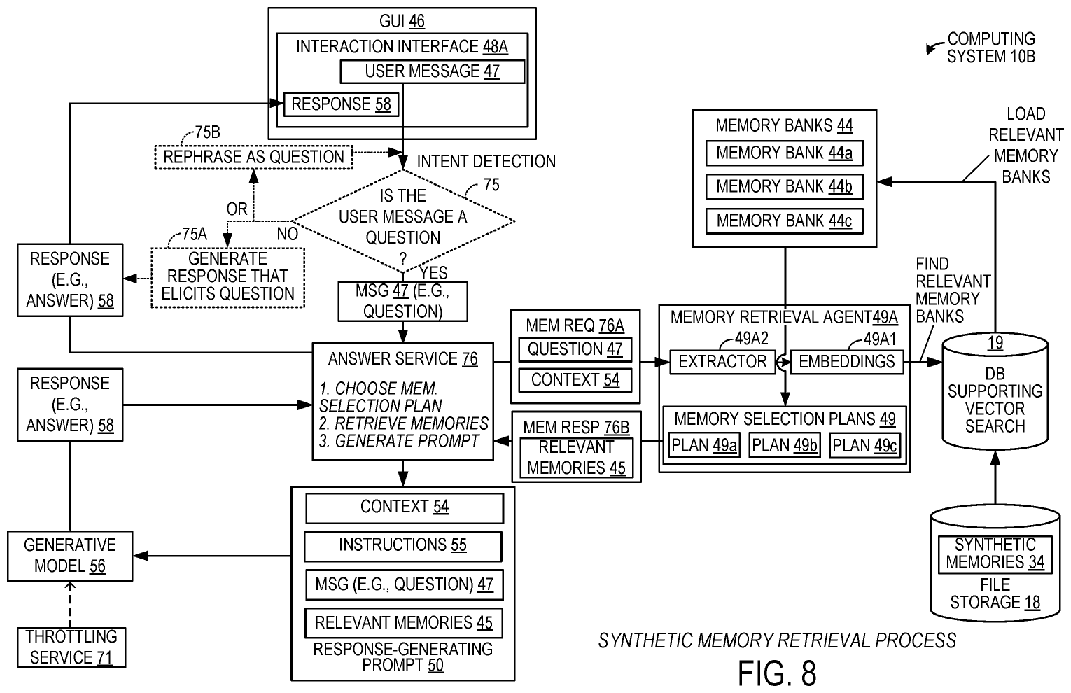

FIG. 6 shows a flowchart for a method 100 for extracting and clustering synthetic memories from a user interaction history. The method 100 may be implemented by the computing system 10 or 10A illustrated in FIGS. 1A and 1B, or via other suitable hardware and software such as that shown at 10B in FIGS. 7 and 8.

At step 102, a user interaction history of a user is received. At step 104, one or more prompts are generated based on the user interaction history. At step 106, synthetic memories are extracted from the user interaction history based on the prompts. At step 108, high-dimensional vectors or embeddings are extracted from the synthetic memories. At step 110, the synthetic memories are consolidated into memory clusters using a density-based clustering algorithm. At step 112, a prompt interface for a trained generative model is presented. At step 114, an instruction is received from a user, via the prompt interface, to generate an output. At step 116, a prompt is generated based on the memory clusters and the instruction from the user. At step 118, the prompt is provided to the trained generative model. At step 120, in response to the prompt, a response is received from the trained generative model. At step 122, the response is outputted to the user.

FIG. 7 illustrates a third example implementation of a computing system 10B. Although not depicted, computing system 10B should be understood to include processing circuitry and associated memory, and a storage device with stored instructions, similar to computing system 10 described above. Computing system 10B is similar to computing system 10 and 10A other than as described below, and the similarities will not be described for the sake of brevity. FIG. 7 illustrates the process of using computing system 10B for synthetic memory encoding. During this process, information is ingested from multiple interaction modalities 69 of the user with the computing system 10B, extracted, consolidated, and stored in a searchable format for retrieval. The process of encoding in FIG. 7 typically runs continuously in parallel with the process of retrieval illustrated in FIG. 8, but could also be batched and run prior thereto.

Computing system 10B includes processing circuitry configured to receive input data 68 from the multiple interaction modalities 69 of the user and generate a multi-interaction-modality user interaction history 32 from the input data 68. The multiple interaction modalities 69 are typically user interactions with multiple different computer services implemented on or accessible from computing system 10B that the user has access to via a user account and associated credentials. The ingestion service 70 utilizes these user credentials to access and ingest input data 68 from each of the different services. As shown, the input data 68 from multiple interaction modalities 69 may include files 68a, chat messages 68b, email messages 68c, calendar information 68d, search and browsing activity 68e, social media activity 68f, gaming activity 68g, and user state 68h. Files 68a can include text and image data from files that have been uploaded, changed, or deleted within a file system of the computing system 10B including collaborative file editing activity from a collaborative editing environment, for example. Chat messages 68b can include text and image data, reaction data, emoji data, external hyperlinks, etc. exchanged between the user and one or more other users or between the user and one or more generative models on the computing system 10B. Likewise, email messages 68c can include emails exchanged between the user and one or more other users or the user and a generative language model on the computing system. Calendar information 68d can include user appointments, user availability information, or other information on the calendar of a user account. Search and browsing activity 68e can include search queries and corresponding search results from intranet or internet searches conducted by a user, and browsing activity conducted by a using a browser (e.g., link trails traversed by a user). Social media activity 68f can include user social media content views, reactions, posts, comments, etc. made by the user via a social media application. Gaming activity 68g can include user achievements, game title usage data, etc. from a computing gaming platform accessible via the computing system 10B. User state 68h can include information indicating the user state in the computing system, such as time periods at which the user is available, busy, away from keyboard, offline, or using a mobile device, applications in-use by a user, and possible other non-personally identifiable information of the user, such as generalized geographic location, age, etc. Typically, all personally identifiable information is either not included in input data 68 or is removed from input data prior to ingestion. Other interaction modalities 69 not shown are also contemplated, as these examples are not meant to be exhaustive.

The input data 68 is ingested via an ingestion service 70, which is configured to process the input data 68 from each of the interaction modalities 69, to generate the multiple-interaction-modality user interaction history 32 including interaction records 32a from each of the plurality of interaction modalities 69. To perform this generation, the ingestion service 70 may be configured by an administrator using a configuration service 72 to perform the ingestion and encoding of the various input data 68 from the different input modalities 69. The administrator may define the types of memories to be extracted and the manner of extraction by providing to the configuration service 72 natural language memory extraction instructions 28b for the memory extraction prompt 28.

The ingestion service 70 may be configured to receive the various input data 68 via specific APIs that facilitate the process of receiving the data from the different inputs, thereby ensuring the compatibility of the input data 68 with memory extractor 24, discussed below, and perform transformations on the input data 68 to generate the multiple-interaction-modality user interaction history 32. The multiple-interaction modality user history 32 typically includes interaction records 32a from the different modalities 69 which are encoded with a timestamp indicating when they occurred. In some implementations, the interaction records 32a can themselves include data combined from two different interaction modalities 69, such as an interaction record that includes both chat and email communications between two users about a topic. In other implementations, each interaction record 32a is based on input data 68 from a corresponding single interaction modality 69.

The processing circuitry is further configured to execute the memory extractor 24, which is configured to extract memories from the multi-interaction-modality user interaction history 32 using a trained memory-extracting generative model 30, the memories including natural language text descriptions of interactions in the user interaction history 32 generated by the memory-extracting generative model 30. The memory extractor 24 includes a prompt generator 26 and the memory-extracting generative model 30, which together form a memory extraction pipeline. Following completion of ingestion, a queue of interaction records 32a from the interaction history 32 is fed through the pipeline, to process all of the interaction records 32a. The trained memory-extracting generative model 30 can be a pre-trained generative language model having a transformer architecture, in one example. Other architectures can also be adopted for such a pre-trained generative language model.

The prompt generator 26 includes a text extraction module 26a and a text partitioning module 26b, via which text from the interaction records 32a is extracted and partitioned. The prompt generator 26 is configured to generate a memory extraction prompt 28 including the extracted and partitioned text 28a from the interaction records 32a and a memory extraction instruction 28b. The prompt generator 26 further includes an instruction module 26c configured to generate a memory extraction instruction 28b to be included in the prompt 28. The extracted and partitioned text is included in prompt 28. Optionally, an imaging processing module may also be included in prompt generator 28, and processed image features (e.g., image embeddings) may be included in the prompt 28. The memory extraction prompt 28 is inputted into the memory-extracting trained language model 30, which in response is configured to generate synthetic memories 34. The synthetic memories 34 are natural language (i.e., semantic) descriptions generated by the memory extracting trained language model 30, based on the input data 68, and thus may also be referred to as semantic memories. These synthetic memories 34 may be represented as natural language text, and/or embeddings of such text, for example. The configuration service 72 may generate plugins 74 that are also inputted as instructions 28b into the prompt 28 for the memory-extracting trained language model 30 to aid in the generation of the synthetic memories 34. The plugins 74 are typically generated based on the memory extraction instructions 26b provided by the administrator using the configuration service 72 as described above. The memory-extracting generative model 30 is configured to generate, in response to the memory extraction prompt 28, synthetic memories 34, which contain natural language descriptions generated by the model 30 of the user interactions detailed in the interaction records 32a from the plurality of different input modalities. The synthetic memories 34 are sent to the memory consolidator 26, which consolidates and stores the synthetic memories 34 in long-term file storage 18. If desired, the multi-interaction-modality user interaction history 32 can also be stored in long-term file storage 18, as can input data 68.

Memory consolidator 26 is configured to receive the synthetic memories 34 from the memory extractor 24, and store the synthetic memories 34 in a flat memory storage 18A of long term file storage 18. Flat memory storage 18A is said to be flat because the synthetic memories 34 are merely stored by filename in file storage 18. To make these synthetic memories 34 easily searchable, the memory consolidator 26 is configured to extract embeddings 40 for each synthetic memory 34 using an embeddings extractor 38 and index the synthetic memories 34 by the embeddings. The embeddings extractor 38 receives input of the synthetic memories 34 to extract (i.e., generate) embeddings 40, which are high dimensional encoded vectors representing the memories, from the synthetic memories 34. These embeddings 40 are stored in a database 19 supporting vector search, and a link or path is also stored in the database 19 to the synthetic memory 34 in file storage 18 associated with each embedding 40. Database 19 contains a vector search interface that is configured to receive memory retrieval queries including query embeddings 49A1 (see FIG. 8) and to search for stored embeddings 40 or embedding clusters 40A associated with the memories 34, to thereby retrieve the relevant memories 34, as described below.

The memory consolidator 26 further includes a density-based clustering algorithm 42 that is executed to cluster the embeddings 40. Embedding clusters 40A generated by the density based clustering algorithm 42 can also be stored in the database 19 supporting vector search, enabling vector search queries to quickly find not only single embeddings 40 but embedding clusters 40A of embeddings 40 for related synthetic memories 34. Memory banks 44 associated with identified embeddings 40 and embedding clusters 40A by the vector search interface can be loaded into working memory during the memory retrieval process, shown in FIG. 8.

Continuing with FIG. 7, embedding clusters 40A are used to group the synthetic memories 34 into a plurality of memory banks 44, also referred to as memory collections or memory clusters. The synthetic memories 34 clustered together in this manner by the clustering algorithm 42 based on their embeddings 40 can be stored in the same memory bank 44. In FIG. 7, three memory banks 44a-c are depicted, but the number of memory banks 44a-c is not particularly limited, and the memory banks 44 may number more than three. The synthetic memories 34 are typically stored in an embedding 40 representation in the memory banks 44, and can optionally be accompanied by a semantic representation of the synthetic memory 34 (i.e., natural language form).

For various reasons, it may be desirable to update the synthetic memories 34 in the memory banks 44. As a first reason, the storage capacity of the memory banks 44 may be limited. As a second reason, the synthetic memories 34 may contain duplicate content that may be summarized in a more efficient form. As a third reason, the computing system 10B may wish to emphasize or deemphasize certain synthetic memories 34, or to revise the content of certain synthetic memories 34. For this purpose, the memory consolidator 26 is configured to implement a memory rewrite module 41 that can consolidate the synthetic memories 34 within the memory banks 44, by rewriting them. The synthetic memories 34 in a cluster or memory bank 44 can be consolidated by sending a rewrite prompt 43 generated by the rewrite module 41 to the memory-extracting language model 30 to thereby rewrite the synthetic memories 34 in the cluster or memory bank 44 as a consolidated synthetic memory 34A.

This consolidation may be performed by the memory rewrite module 41 sending the rewrite prompt 43 to the memory-extracting trained language model 30, to concisely summarize multiple synthetic memories 34, to revise a synthetic memory 34 to place more or less emphasis on certain semantic content of the synthetic memory 34, etc. The output of the memory-extracting trained language model 30 in response to this rewriting prompt 43 can then be stored within the memory banks 44. The memory rewrite module 41 can be configured to rewrite an entire cluster of synthetic memories 34, a subset of synthetic memories 34 within a cluster, or a specific synthetic memory 34, in this manner.

The computing system 10B of FIG. 7 is further illustrated in FIG. 8, showing the synthetic memory retrieval process, which typically occurs after the memories are encoded using the process illustrated in FIG. 7, although the processes of FIGS. 7 and 8 can proceed in parallel and run continuously. As shown in FIG. 8, computing system 10B is configured to implement the trained generative model 56, and instantiate an interaction interface 48A for the generative model 56. The interaction interface 48A is typically displayed within a graphical user interface (GUI) 46, but may alternatively be an application programming interface configured for software to software communication. In one example, the interaction interface 48A can be in the form of a prompt interface 48 of a chat bot, described above in relation to computing system 10 and 10A. The computing system 10B is configured to receive, via the interaction interface 48A, user input of a user message 47 including text, and display a response 58 generated after retrieving relevant memories 45 related to the user message 47. The response 58 is generated in the following manner.

First, in some configurations of the computing system 10B, it may be desirable to determine whether the user message 47 is a question. Thus, processing circuitry of the computing system 10B may be configured to determine, at decision point 75, whether the user message 47 is a question. If so (YES at 75) the computing system 10B then attempts to generate a response 58 in the form of an answer to the message 47, which is in the form of the question, using the generative model 56, by calling an answer service 76 to generate a response 58. The determination at 75 can be performed using a machine learning model configured to perform intent detection on the incoming user message, which model has been trained based on ground truth example user inputs labeled as question or not question, to detect whether inference time input is a question. If the user message 47 is determined not to be a question, the processing circuitry of computing system 10B may be configured to generate a response, as shown at 75A, using generative model 56 or otherwise, that elicits a question from the user. This may be as simple outputting in response to a non-question: “I'm afraid I'm not sure if you are asking me a question. Do you have a question for me?” or “I see you mention Istanbul, would you like more information about the city?” Alternatively, the computing device 10B may be configured to rephrase the user message 47 as a question, as shown at 75B. For example, a user message 47 of “I am going sightseeing in Istanbul next month” could be sent with a prompt to the generative model 56, which requests the model to rephrase the user message as a question about the topic of the user message. For example, the model in response to this prompt might rephrase the user message as a question as follows: “What are some locations to sightsee in Istanbul?” and pass this modified user message 47 in question form in response-generating prompt 50 to the generative model 56. In other implementations intent detection is not performed at decision point 75, and instead the user message 47 is passed to the answer service 76 without checking whether it is a question. In this case the answer service 76 simply generates a response including information related to the user message 47.

As alluded to above, the answer service 76 is configured to generate a response-generating prompt 50 and send the response-generating prompt 50 to the generative model 56 to thereby generate a response 58 to the user message 47. To generate the response-generating prompt 50, the answer service 76 is configured to generate a context 54 for the user message 47. The context 54 can be generated to include one or more prior user messages 47 and responses 58 in a current chat session between the user and the generative model 56 in the interaction interface 48A, for example.

The answer service 76 is configured to send a memory retrieval request 76A to a memory retrieval agent 49A, the memory retrieval request 76A including the context 54 and the message 47. Further, the answer service 76 is configured to receive relevant memories 45 from the memory retrieval agent 76 in a memory retrieval response 76B. The memory retrieval agent 49A is configured to extract relevant memories 45 in the manner described with respect to FIG. 7. Thus, the relevant memories 45 have been extracted from a multi-interaction-modality user interaction history 32 created using a trained memory-extracting generative model 30, and the relevant memories 45 include natural language text descriptions of interactions from multiple interaction modalities 69 included in the multi-interaction-modality user interaction history 32, as described above in relation to FIG. 7. As described above, the input data from multiple interaction modalities 69 can include input data selected from two or more the group of input modalities consisting of: files, chat messages, email messages, calendar information, search and browsing activity, social media activity, gaming activity, and user state. Other input modalities are also contemplated as this list is not exhaustive. It should be noted that in implementations in which the computing system 10B is configured to perform intent detection on the user message to determine that the user message 47 is a question, the answer service 76 is configured to generate the response-generating prompt 50 to further include the question.

It should be understood that memory selection plans 49A can be utilized to customize the type and manner in which relevant memories 45 are selected from among matching memories 34 in the vector search. Prior to sending the memory request 76A, the answer service 76 chooses a memory selection plan 49 from a plurality of memory selection plans 49a-c based upon the context 54 and question 47. Thus, in the memory retrieval request, the answer service 76 can include a command requesting the memory retrieval agent 49A to find and load relevant memories 45 according to the chosen memory selection plan 49 (such as plan 49a, 49b, 49c, etc. Once a memory retrieval response 76B is received based on the chosen selection plan, the answer service 76 can generate a response 58 to the user message 47 by sending the prompt 50, including question 52, context 54, and relevant memories 45, to the generative model 56, which in turn generates the response 58 and returns the response 58 for output via the interaction interface 48A.

In response to receiving the memory retrieval request 76A from the answer service 76, the memory retrieval agent 49A is configured to generate embeddings 49A1 for the user message 47 and context 54 using an embedding extractor 49A2. Using embeddings 49A1, the memory retrieval agent 49A is configured to find relevant memories 45 by conducting a vector search in the database 19 where memories are indexed by embeddings. After finding matching embeddings using the vector search, the memory retrieval agent 49A loads the relevant memories 45 into working memory. In the illustrated embodiment, matching clusters of synthetic memories 34 are loaded as memory banks 44 into working memory and returned as relevant memories 45. Since the embeddings are clustered into memory banks 44 by the density based clustering algorithm 42 shown in FIG. 7, the relevant memories 45 may be clustered memories in a memory bank 44. As an alternative, a subset of the memories 34 clustered in memory banks 44 may be returned as relevant memories 45. The subset may be selected according to the memory selection plan(s) 49 currently being utilized by the memory retrieval agent, as discussed above. For example, the memory selection plan may choose from among the memories in the memory banks based on semantic similarity of the embeddings 40 for the memories 34 to embeddings 49A1 for semantic selection criteria of the selected memory selection plan 44. To achieve this, the memory banks 44 in working memory may be configured as a database supporting vector search, so that the embeddings 40 associated with the synthetic memories 34 within the memory banks 44 may be searched to retrieve the relevant memories 45.

In addition, the answer service 76 can be further configured to generate the response-generating prompt 50 to further include one or more instructions 55 to the trained generative model 56. Instructions 55 are typically in natural language form. An example instruction is “Formulate an answer to the question given the context and relevant memories, first summarizing the question and then stating a succinct answer, and then giving detailed statements providing evidence, sources, or reasons for the answer. The answer should be in one paragraph form.”

The memory-extracting trained language model 30, in some example implementations, can be the same as the generative model 56 that is used to generate the answer 58 from the user question 47. It will be appreciated that, when the memory-extracting trained language model 30 is the same as the generative model 56, a priority-based throttling service 71 may be employed for resource allocation to manage the use of each of the language models 30, 56 by the memory extractor 24 and the answer service 76. Priority levels may dictate the rate at which the memory extractor 24 and the answer service 76 can access and use the language model 30, 56. When a request to access the language models 30, 56 is received from the memory extractor 24 or the answer service 76, the throttling service 71 checks the priority assigned to the memory extractor 24 and the answer service 76, respectively. Based on the current system load and the priority of the request, the throttling service 71 then determines whether to grant immediate access, delay the access, or reject the request if the system 10B is at its maximum capacity.

In sum, the answer service 76 is configured to generate response-generating prompt 50 including the user message 47, the context 54, the instruction 55, and the relevant memories 45 received from the memory retrieval agent 49A. The answer service 76 is configured to provide the response-generating prompt 50 to the trained generative model 56, which may be a pre-trained generative language model based on a transformer architecture or other model type as discussed herein. The trained generative model 56 is configured to generate response 58 based on the response-generating prompt 50. It will be appreciated that this model may be executed on the same server as the remainder of computing system 10B, or on a different server, as discussed above. The answer service of the computing system 10B is configured to receive the response 58 generated by the trained generative model 56 in response to the response-generating prompt, and output the response 58 via the interaction interface 48A. The output may be by displaying in a graphical user interface or via communication via an application programming interface, as appropriate.

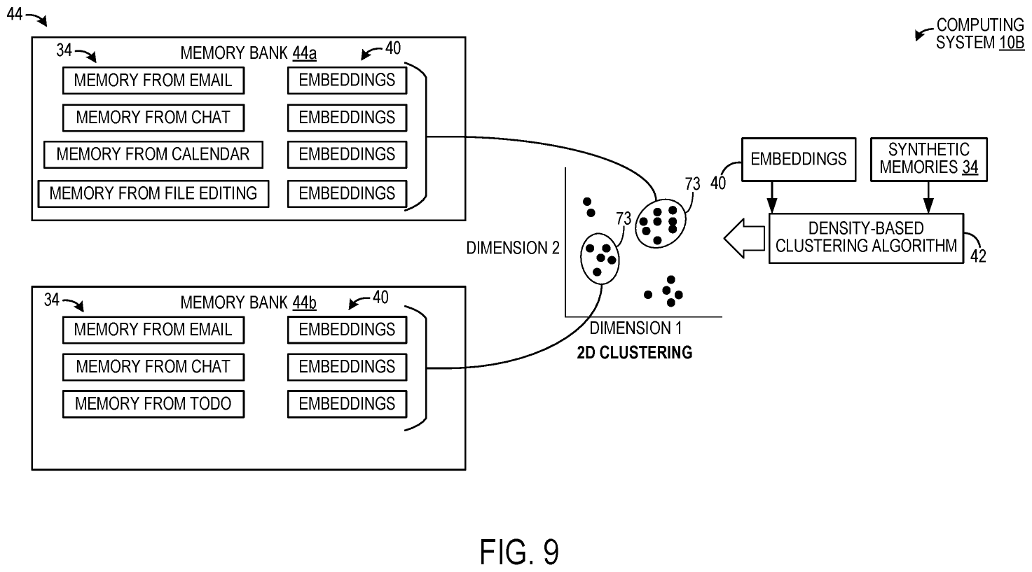

FIG. 9 shows a schematic view of the computing system 10B of FIGS. 7 and 8 clustering the synthetic memories 34 into memory clusters 73 stored in memory banks 44, using the density based clustering algorithm 42. As shown, the high dimensionality embeddings 40 are represented in a reduced dimensionality space, such as a 2D space by a dimension reduction technique, and clusters 73 are identified by a clustering technique, in the density-based clustering algorithm. As shown, the embeddings 40 from synthetic memories 34 from different input modalities 69 that are in the same identified cluster 73 are included in a the same memory bank 44. Thus, due to their embedding similarity, selected synthetic memories 34 from email, chat, calendar and file editing modalities are included in memory bank 44a, and selected synthetic memories 34 from email, chat, and to do modalities are included in memory bank 44b.

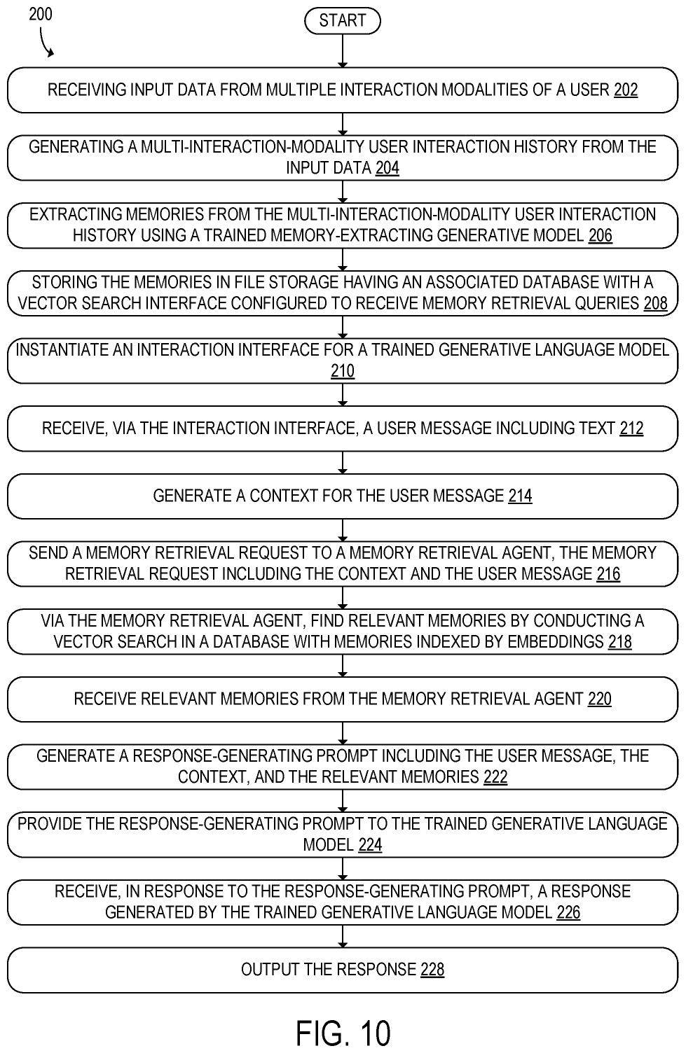

Turning now to FIG. 10, a flowchart of a computing method 200 for synthetic memory encoding and/or retrieval according to another example implementation of the present disclosure is illustrated. Method 200 may be implemented using the computer hardware and software of computer system 10, 10A and 10B described above, or other suitable computer hardware and software. At 202, the method includes receiving input data from multiple interaction modalities of a user. At 204, the method includes generating a multi-interaction-modality user interaction history from the input data. At 206, the method includes extracting memories from the multi-interaction-modality user interaction history using a trained memory-extracting generative model, the memories including natural language text descriptions of interactions in the user interaction history generated by the trained memory-extracting generative model. At 208, the method includes storing the memories in file storage having an associated database with a vector search interface configured to receive memory retrieval queries. At 210, the method includes instantiating an interaction interface for a trained generative model. At 212, the method includes receiving, via the interaction interface, a user message including text. At 214, the method includes generating a context for the user message. At 216, the method includes sending a memory retrieval request to a memory retrieval agent, the memory retrieval request including the context and the user message. At 218, the method includes via the memory retrieval agent, finding relevant memories by conducting a vector search in a database where memories are indexed by embeddings. As described above, conducting a vector search includes performing a similarity comparison on embeddings for the context and user message to the embeddings for the memories. At 220, the method includes receiving relevant memories from the memory retrieval agent. At 222, the method includes generating a response-generating prompt including the user message, the context, and the relevant memories. At 224, the method includes providing the response-generating prompt to the trained generative model. At 226, the method includes receiving, in response to the response-generating prompt, a response generated by the trained generative model. And, at 228, the method includes outputting the response. It will be appreciated that the multiple interaction modalities includes two or more input modalities selected from the group consisting of: files, chat messages, email messages, calendar information, search and browsing activity, social media activity, gaming activity, and user state. Further, the trained memory-extracting generative model and the trained generative model can be different models, or the same model. In one example, the interaction interface is a graphical user interface, and the response is displayed in the graphical user interface. In another example, the interaction interface is an application programming interface.

The above-described system and method address the context loss problem in user interactive systems by leveraging historical user interactions and integrating them into current and future user interaction sessions, thereby offering a context-rich, personalized, and meaningful conversational experience.

In some embodiments, the methods and processes described herein may be tied to a computing system of one or more computing devices. In particular, such methods and processes may be implemented as a computer-application program or service, an application-programming interface (API), a library, and/or other computer-program product.

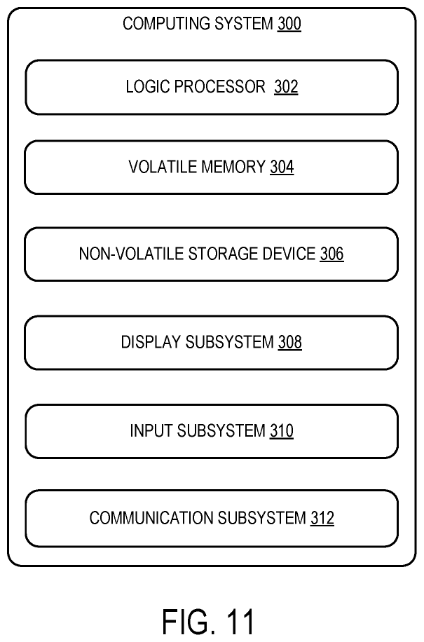

FIG. 11 schematically shows a non-limiting embodiment of a computing system 300 that can enact one or more of the methods and processes described above. Computing system 300 is shown in simplified form. Computing system 300 may embody the computing system 10, 10A, and 10B described above and illustrated in FIGS. 1A, 1B, and FIGS. 7 and 8 respectively. Components of computing system 300 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 11.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

Below, several aspects of the subject application are additionally described. According to a first aspect, a computing system for synthetic memory encoding is provided, comprising processing circuitry configured to receive input data from multiple interaction modalities of a user; generate a multi-interaction-modality user interaction history from the input data; extract memories from the multi-interaction-modality user interaction history using a trained memory-extracting generative model, the memories including natural language text descriptions of interactions in the user interaction history generated by the trained memory-extracting generative generative model; and store the memories in file storage having an associated database with a vector search interface configured to receive memory retrieval queries.

In this aspect, the multiple interaction modalities can include two or more input modalities selected from the group consisting of: files, chat messages, email messages, calendar information, search and browsing activity, social media activity, gaming activity, and user state. In this aspect, the input data can be ingested via an ingestion service configured to process the input data from each of the interaction modalities, to generate the multiple interaction modality user interaction history including interaction records from each of the plurality of interaction modalities. In this aspect the memories can be extracted by extracting and partitioning text in the interaction records of the interaction history; generating a memory extraction prompt including the extracted and partitioned text from the interaction records and a memory extraction instruction; and inputting the generated memory extraction prompt into the trained memory-extracting generative model, which in response is configured to generate the memories. In this aspect, the memories can be clustered into the memory clusters by extracting embeddings from the memories and clustering the embeddings using a density-based clustering algorithm; and the memories in a cluster can be consolidated by sending a rewrite prompt to the memory-extracting language model to thereby rewrite the memories in the cluster as a consolidated memory. In this aspect, the memory clusters can be configured as memory banks in the database, and the search interface can be configured to receive a query including query embeddings, and to search for stored embeddings associated with the memories within the memory banks, to thereby retrieve the relevant memories. In this aspect, the trained memory-extracting generative model can be a pre-trained generative language model having a transformer architecture.

According to another aspect, a computing system for synthetic memory retrieval is provided, comprising processing circuitry configured to instantiate an interaction interface for a trained generative model; receive, via the interaction interface, a user message including text; generate a context for the user message; send a memory retrieval request to a memory retrieval agent, the memory retrieval request including the context and the user message; and receive relevant memories that are relevant to the context and user message from the memory retrieval agent, wherein the relevant memories have been extracted from a multi-interaction-modality user interaction history created using a trained memory-extracting generative model, the relevant memories including natural language text descriptions of interactions from multiple interaction modalities included in the multi-interaction-modality user interaction history.

In this aspect, the processing circuitry can be further configured to, at the memory retrieval agent, generate embeddings for the user message and context, find relevant memories by conducting a vector search in a database where memories are indexed by embeddings, and load the relevant memories into working memory. In this aspect, the embeddings can be clustered into memory banks by a density based clustering algorithm, and the relevant memories can be clustered memories in a memory bank. In this aspect, the processing circuitry can be further configured to generate a response-generating prompt including the user message, the context and the relevant memories; provide the response-generating prompt to a trained generative model; receive, in response to the response-generating prompt, a response generated by the trained generative model; and output the response.

In this aspect, the processing circuitry can be further configured to perform intent detection on the user message to determine that the user message is a question, and generating the response-generating prompt can include generating the response-generating prompt to further include the question. In this aspect, the processing circuitry can be further configured to generate the context to include one or more prior user messages and responses in a current chat session between the user and the trained generative model in the interaction interface. In this aspect, the processing circuitry can be further configured to generate the response-generating prompt to further include one or more instructions to the trained generative model. In this aspect, the trained generative model can be a pre-trained generative language model having a transformer architecture. In this aspect, the multiple interaction modalities can include two or more input modalities selected from the group consisting of: files, chat messages, email messages, calendar information, search and browsing activity, social media activity, gaming activity, and user state.

According to another aspect, a computing method for synthetic memory encoding and retrieval is provided, comprising receiving input data from multiple interaction modalities of a user; generating a multi-interaction-modality user interaction history from the input data; extracting memories from the multi-interaction-modality user interaction history using a trained memory-extracting generative model, the memories including natural language text descriptions of interactions in the user interaction history generated by the trained memory-extracting generative model; storing the memories in file storage having an associated database with a vector search interface configured to receive memory retrieval queries; instantiating an interaction interface for a trained generative language model; receiving, via the interaction interface, a user message including text; generating a context for the user message; sending a memory retrieval request to a memory retrieval agent, the memory retrieval request including the context and the user message; via the memory retrieval agent, finding relevant memories by conducting a vector search in a database where memories are indexed by embeddings, wherein conducting a vector search includes performing a similarity comparison on embeddings for the context and user message to the embeddings for the memories; receiving relevant memories from the memory retrieval agent; generating a response-generating prompt including the user message, the context, and the relevant memories; providing the response-generating prompt to the trained generative language model; receiving, in response to the response-generating prompt, a response generated by the trained generative language model; and outputting the response.

In this aspect, the multiple interaction modalities can include two or more input modalities selected from the group consisting of: files, chat messages, email messages, calendar information, search and browsing activity, social media activity, gaming activity, and user state. In this aspect, the trained memory-extracting generative model and the trained generative language model can be a same model. Further in this aspect, the interaction interface can be a graphical user interface, and the response can be displayed in the graphical user interface.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for synthetic memory encoding, comprising:
processing circuitry configured to:
receive input data from multiple interaction modalities of a user;
generate a multi-interaction-modality user interaction history from the input data;
extract memories from the multi-interaction-modality user interaction history using a trained memory-extracting generative model, the memories including natural language text descriptions of interactions in the user interaction history generated by the trained memory-extracting generative generative model; and
store the memories in file storage having an associated database with a vector search interface configured to receive memory retrieval queries.

2. The computing system of claim 1, wherein the multiple interaction modalities includes two or more input modalities selected from the group consisting of: files, chat messages, email messages, calendar information, search and browsing activity, social media activity, gaming activity, and user state.

3. The computing system of claim 1, wherein the input data is ingested via an ingestion service configured to process the input data from each of the interaction modalities, to generate the multiple interaction modality user interaction history including interaction records from each of the plurality of interaction modalities.

4. The computing system of claim 3, wherein the memories are extracted by:
extracting and partitioning text in the interaction records of the interaction history;
generating a memory extraction prompt including the extracted and partitioned text from the interaction records and a memory extraction instruction; and
inputting the generated memory extraction prompt into the trained memory-extracting generative model, which in response is configured to generate the memories.

5. The computing system of claim 1, wherein
the memories are clustered into the memory clusters by extracting embeddings from the memories and clustering the embeddings using a density-based clustering algorithm; and
the memories in a cluster are consolidated by sending a rewrite prompt to the memory-extracting language model to thereby rewrite the memories in the cluster as a consolidated memory.

6. The computing system of claim 5, wherein the memory clusters are configured as memory banks in the database, and the search interface is configured to receive a query including query embeddings, and to search for stored embeddings associated with the memories within the memory banks, to thereby retrieve the relevant memories.

7. The computing system of claim 1, wherein the trained memory-extracting generative model is a pre-trained generative language model having a transformer architecture.

8. A computing system for synthetic memory retrieval, comprising:
processing circuitry configured to:
instantiate an interaction interface for a trained generative model;
receive, via the interaction interface, a user message including text;
generate a context for the user message;
send a memory retrieval request to a memory retrieval agent, the memory retrieval request including the context and the user message; and
receive relevant memories that are relevant to the context and user message from the memory retrieval agent, wherein the relevant memories have been extracted from a multi-interaction-modality user interaction history created using a trained memory-extracting generative model, the relevant memories including natural language text descriptions of interactions from multiple interaction modalities included in the multi-interaction-modality user interaction history.

9. The computing system of claim 8, wherein the processing circuitry is further configured to:
at the memory retrieval agent,
generate embeddings for the user message and context;
find relevant memories by conducting a vector search in a database where memories are indexed by embeddings; and
load the relevant memories into working memory.

10. The computing system of claim 9, wherein the embeddings are clustered into memory banks by a density based clustering algorithm, and the relevant memories are clustered memories in a memory bank.

11. The computing system of claim 8, wherein the processing circuitry is further configured to:
generate a response-generating prompt including the user message, the context and the relevant memories;
provide the response-generating prompt to a trained generative model;
receive, in response to the response-generating prompt, a response generated by the trained generative model; and
output the response.

12. The computing system of claim 11, wherein the processing circuitry is further configured to:
perform intent detection on the user message to determine that the user message is a question, and wherein
generating the response-generating prompt includes generating the response-generating prompt to further include the question.

13. The computing system of claim 11, wherein the processing circuitry is further configured to:
generate the context to include one or more prior user messages and responses in a current chat session between the user and the trained generative model in the interaction interface.

14. The computing system of claim 11, wherein the processing circuitry is further configured to:
generate the response-generating prompt to further include one or more instructions to the trained generative model.

15. The computing system of claim 11, wherein the trained generative model is a pre-trained generative language model having a transformer architecture.

16. The computing system of claim 11, wherein the multiple interaction modalities includes two or more input modalities selected from the group consisting of: files, chat messages, email messages, calendar information, search and browsing activity, social media activity, gaming activity, and user state.

17. A computing method for synthetic memory encoding and retrieval, comprising:
receiving input data from multiple interaction modalities of a user;
generating a multi-interaction-modality user interaction history from the input data;
extracting memories from the multi-interaction-modality user interaction history using a trained memory-extracting generative model, the memories including natural language text descriptions of interactions in the user interaction history generated by the trained memory-extracting generative model;
storing the memories in file storage having an associated database with a vector search interface configured to receive memory retrieval queries;
instantiating an interaction interface for a trained generative language model;
receiving, via the interaction interface, a user message including text;
generating a context for the user message;
sending a memory retrieval request to a memory retrieval agent, the memory retrieval request including the context and the user message;
via the memory retrieval agent, finding relevant memories by conducting a vector search in a database where memories are indexed by embeddings, wherein conducting a vector search includes performing a similarity comparison on embeddings for the context and user message to the embeddings for the memories;
receiving relevant memories from the memory retrieval agent;
generating a response-generating prompt including the user message, the context, and the relevant memories;
providing the response-generating prompt to the trained generative language model;
receiving, in response to the response-generating prompt, a response generated by the trained generative language model; and
outputting the response.

18. The computing method of claim 17, wherein the multiple interaction modalities includes two or more input modalities selected from the group consisting of: files, chat messages, email messages, calendar information, search and browsing activity, social media activity, gaming activity, and user state.

19. The computing method of claim 17, wherein the trained memory-extracting generative model and the trained generative language model are a same model.

20. The computing method of claim 17, wherein the interaction interface is a graphical user interface, and the response is displayed in the graphical user interface.
